(19) United States
(12) Patent Application Publication
(10) Pub. No.: US 2013/0173653 A1
(43) Pub. Date: Jul. 4, 2013

(54) PATH COMPOSITION FOR PLANNING

(71) Applicants: Brian Beckman, Newcastle, WA (US); Eyal Ofek, Redmond, WA (US); Gur Kimchi, Bellevue, WA (US); Elad Gerson, Seattle, WA (US); Richard A. Clawson, Sammamish, WA (US)

(72) Inventors: Brian Beckman, Newcastle, WA (US); Eyal Ofek, Redmond, WA (US); Gur Kimchi, Bellevue, WA (US); Elad Gerson, Seattle, WA (US); Richard A. Clawson, Sammamish, WA (US)

(73) Assignee: MICROSOFT CORPORATION, Redmond, WA (US)

(21) Appl. No.: 13/341,883

(22) Filed: Dec. 30, 2011

(51) Int. Cl. G06F 17/30

(52) U.S. Cl. 707/769; 707/798; 707/E17.014; 707/E17.045

(57) ABSTRACT

A sequence of events may be planned by drawing on knowledge of existing sequences of events, and combining those events in accordance with a set of constraints. In one example, the sequences of events are events in a social agenda, such as dinner, drinks, movie, etc. Actual social agendas that users have carried out are monitored (with the users' permission), and these events are stored in a database. A sequence of events may be referred to as an existing path. Using the database, a system can respond to a query such as “plan an evening in Seattle,” or “plan an evening in that includes a movie” by querying the database to determine what sequences have already happened, and either retrieving an existing sequence or synthesizing a new one from existing sequences.

### BACKGROUND

When a solution to a problem is called for, one of the simplest ways to provide the solution is to retrieve an existing solution from a database. However, when the problem space is sufficiently large, it is unlikely that an existing solution to the problem exists. For example, if the problem is providing directions from point A to point B, the simplest solution may be to retrieve an existing set of directions. But if points A and B can be any addresses in the United States, then the number of possible combinations of A and B is very large and it is unlikely that directions from A to B actually exist.

Because a solution to the exact problem in question often does not exist, systems that provide such solutions have various ways of synthesizing the solutions. One way of synthesizing a solution is to store information, and to combine pieces of information into a complete solution. For example, a system can translate a document from one language to another by combining known translations of sentence fragments that appear in the document. Or a system can build a set of driving directions from point A to point B by combining small, overlapping routes.

While the idea of building a solution to a problem from smaller bits of information has been applied to driving directions and language translation, there are other contexts in which such techniques can be applied.

### SUMMARY

The planning of a social agenda may be performed by combining existing sequences of events that have been carried out by other people. The method of combining the existing events may take into account arbitrary notions of merit, implemented through pluggable functions.

A social agenda may be, for example, a list of things to do on a particular evening in a particular sequence—e.g., drinks, followed by dinner, followed by a movie, followed by coffee, etc. Some sequences of events work well and others do not. Moreover, in business settings, it is common for people to have to plan a social agenda with their business colleagues in an unfamiliar city. The problem of planning such an agenda may be solved by storing sequences of events that other people have actually carried out, and piecing together an agenda based on the merit of particular events, and the merit of particular transitions between those events. Thus, when people participate in social events, their activities might be tracked through Global Positioning System (GPS) trails, credit card receipts, etc. (Such tracking may be done pursuant to appropriate permission obtained from the user in order to preserve the user's interest in privacy.) Thus, it might be known that one person went to Ruth's Chris for drinks followed by El Gaucho for dinner, followed by a movie at the Kirkland Cinema. Another person may have gone to El Gaucho for dinner, followed by Starbucks for coffee, followed by Tukwila Bowl for bowling. Data representing these kinds of behaviors may be stored in a database, so that it can serve as a source of possible sequences of events.

At some point in time, a user may request to plan a social agenda. The user could specify the agenda at any level of detail—e.g., “plan an evening with dinner, drinks and coffee in Seattle,” or “plan an evening in Seattle that includes El Gaucho,” or “plan a wild evening in Seattle,” or “plan a random evening in the western United States.” Based on whatever criteria are specified, the system attempts to build a sequence of events from existing sequences that have actually been carried out by people. In order to build the path, the system starts at a beginning or ending state of the agenda—either a beginning or ending state that has been specified by the user, or one that has been chosen by the system in the case where the user has not specified a beginning or ending state. The system then looks for existing sequences of events that contain the chosen state, and attempts to build from one end of the agenda to another by choosing fragments from the existing sequences. Where more than one sequence contains the existing state, the system may choose several paths containing that state, and may calculate merit scores for each path. Known paths may take people's ratings of events into account, and these ratings may inform the merit score calculation—e.g., if a person goes to El Gaucho and rates it five out of five stars, this type of rating information may be available to the merit calculation functions and may be taken into account by those functions. Additionally, the merit functions may be pluggable—e.g., users or administrators may specify their own merit functions and/or modify existing ones, in order to affect the types of paths that are chosen.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process of collecting information about sequences of events.

FIG. 2 is a flow diagram of an example process of processing a request to provide a plan or agenda.

FIG. 3 is a flow diagram of an example process of generating a plan that responds to a query.

FIG. 4 is a flow diagram of an example process of making a merit calculation and choosing path fragments.

FIG. 5 is a block diagram of example components that may be used in connection with implementations of the subject matter described herein.

### DETAILED DESCRIPTION

The subject matter herein collects information about plans (e.g., social plans) that people have actually carried out. The collected information may be used to synthesize an agenda, where the agenda responds to some type of request. E.g., a user might say, “plan an evening in Seattle that includes a movie.” A system can use collected information to plan such an evening, by piecing together sequences of events that people have experienced in the past. The diagrams herein show aspects of the collection process, and also the process of generating an agenda from the collected information. Generating a social agenda is an example use of the system, although the system could be used to generate other agendas, or—more generally—any type of plans that involve a sequence of events.

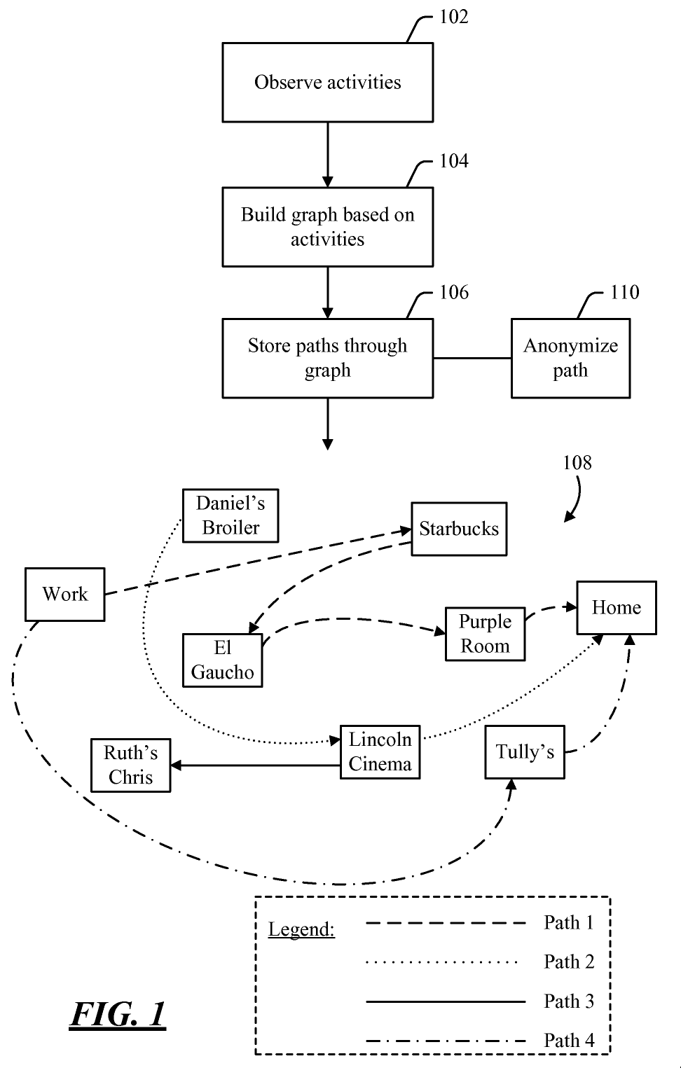

Turning now to the drawings, FIG. 1 shows an example process of collecting information about sequences of events that people have actually experienced. Before turning to a description of FIG. 1, it is noted that each of the flow diagrams herein shows an example in which stages of a process are carried out in a particular order, as indicated by the lines connecting the blocks, but the various stages shown in these diagrams can be performed in any order, or in any combination or sub-combination.

At 102, activities that have been carried out by people are observed. “Activities” can include any type of activity. For example, going to dinner, going out for coffee, going to work, seeing a movie, etc., are examples of activities that can be observed. The observation of these activities can be performed in any manner—e.g., receiving self-reports from users, following charge card transactions, following Global Positioning System (GPS) trails, etc. (It is noted that following a user's whereabouts raises privacy issues. In order to preserve the user's interest in privacy, appropriate permission may be obtained from the user before using information about his or her whereabouts.)

Although any type of activity could be recorded, the following is an example of some sequences of actions that may have been carried out by a person. The type of actions in the forgoing example may be considered to be part of a social agenda. (These examples are expressed in a declarative language, such as Datalog.):

route(danny,

work(danny),
starbucks42,
{elGaucho, 5},
purpleRoom,
home(danny));

route(danny,

danielsBroiler,
lincolnSquareCinema({movie(greenLantern), 2}),
home(danny));

route(danny,

lincolnSquareCinema({movie(badTeacher), 2}),
ruthsChris);

route(danny,

work(danny),
{tullys9, 4},
home(danny));

The foregoing example show four sequences of events that a hypothetical person named Danny has experienced. Each event may be understood to be a node in a graph, so each sequence of events may be understood as a route or path through that graph. In the first path, Danny went to his workplace, then when to Starbucks #42, then to the restaurant El Gaucho (which Danny rated it a “5”), then to the Purple Room, and then to his home. In the second path, Danny went to the restaurant Daniels Broiler, then to the Lincoln Square Cinema to see a particular movie (which he rated a “2”), and then to his home. The third and fourth paths can be understood similarly. It will be understood that a declarative language, like that shown above, is a convenient way to express what a person did, although the sequence of actions that a person has experienced could be expressed in any way, and could be represented using any appropriate data.

At 104, a graph may be built based on the activities that were observed at 102. For example, each place that people have been observed to have visited (e.g., El Goucho, Lincoln Square Cinema, etc.) may be a node in the graph, and transitions between one place and another place may be edges in the graph. At 106, the graph, including known paths through the graph, may be stored. An example of a graph 108 is shown in FIG. 1, which is based on the examples of Danny's activities listed above. Each place that someone has visited is a node in the graph, and when a person has been observed to go from point A to point B, there is a directed edge from A to B in the graph. (Information such as the movie ratings shown above could also be stored in the graph, and these ratings could be used as part of the merit calculation described below—e.g., by assigning higher merit scores to paths that include highly-rated events.) It is noted that the example graph 108 shows only Danny's events; however, a graph could include events from many users—e.g., the millions of users who subscribe to a particular service.

When paths through the graph are stored, the paths may be anonymized (at 110) in order to protect the privacy of people who have actually carried out the activities in the path. For example, Danny might not object to a system's storing information about where he has been, but might not want that information to be easily associated with his identity. Thus, in addition to removing any actual indication of Danny's name, information that might be used to identify Danny might be removed from the path information—e.g., Danny's home and workplace could be removed from the paths. Editing the path information by removing these types of destinations may lessen the amount of information that the system has to work with when constructing paths; however, since Danny's home and workplace are unlikely to be social destinations for anyone except people who know Danny, it is unlikely that information about Danny's workplace or home would be helpful in constructing social agendas for other people. Thus, the cost of removing this information is small, particularly if removing this type of identifying information makes Danny feel more comfortable about sharing his activities with the system.

Additionally, in order to aid efficient retrieval, subpaths of an observed path may be stored. For example, if the path A->B->C->D has been observed, this path may be stored along with three-node subsets (A->B->C and B->C->D), and two-node subsets (A->B, B->C, and C->D).

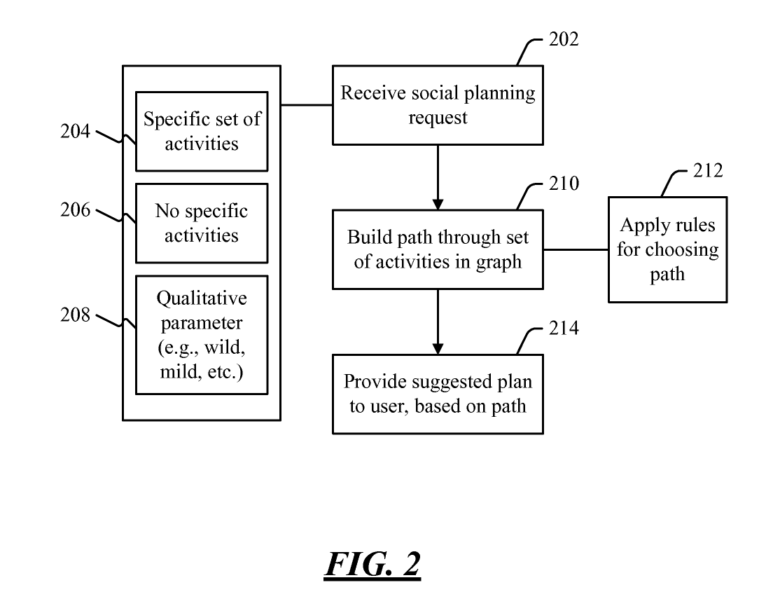

FIG. 2 shows an example process of processing a request to provide a plan or agenda, such as a social plan or agenda.

At 202, a request for planning (e.g., social planning) is received. The request is effectively a query that specifies the type of plan that is being requested. This query may take various forms, and may request plans at various levels of specificity. In one example, the query requests a specific set of activities, optionally in a specific order (block 204)—e.g., “drinks, followed by movie, followed by dinner, followed by coffee.” In another example, the query contains no specific activities (block 206)—e.g., “plan an evening in Seattle”, “plan a weekend in California wine country,” or “plan a random evening anywhere in North America.” In another example, the query contains qualitative parameters (block 208)—e.g., “plan a wild evening,” “plan a mild evening,” or “plan a relaxing week-long trip to the midwest,” where “wild,” “mild,” and “relaxing” will be understood to be examples of qualitative parameters. It is noted that the query is not necessarily made explicitly by the user. For example, a system might react to a user's context, such as events in which the user is currently participating or in which he has recently participated, and may implicitly formulate a query for further planning. As one specific example, a user might be at the Lincoln Square Cinema in Bellevue; a system might detect this fact, infer that the user is out for a “night on the town.” The system could then formulate an implicit query, such as “mild evening after Lincoln Square Cinema”. It could then generate a social agenda based on this query, and push them to the user without the user's having to request a social agenda explicitly. The system might then push this information to the user as a notification—e.g., the information might be created as a message on the user's phone, and a tone or vibration might notify the user that this information is available to him.

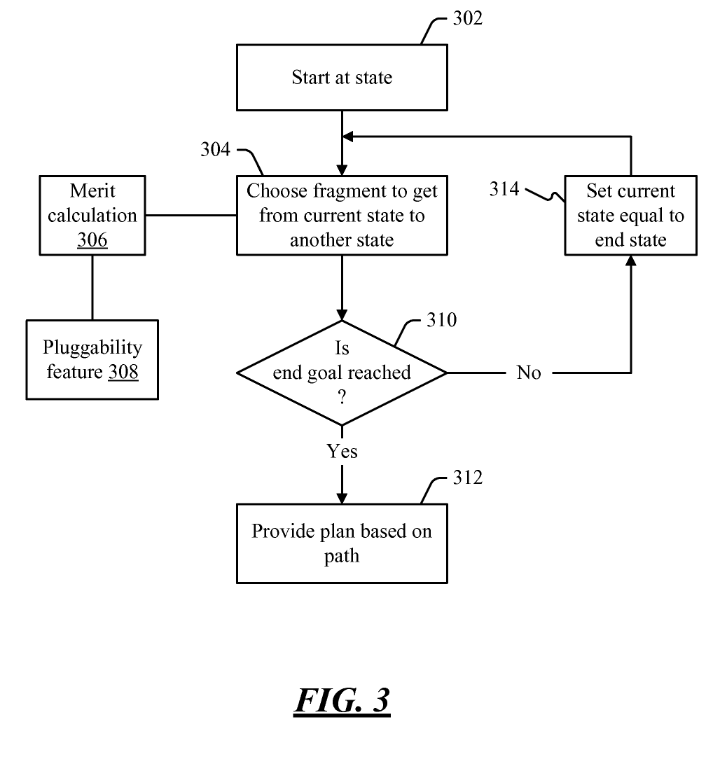

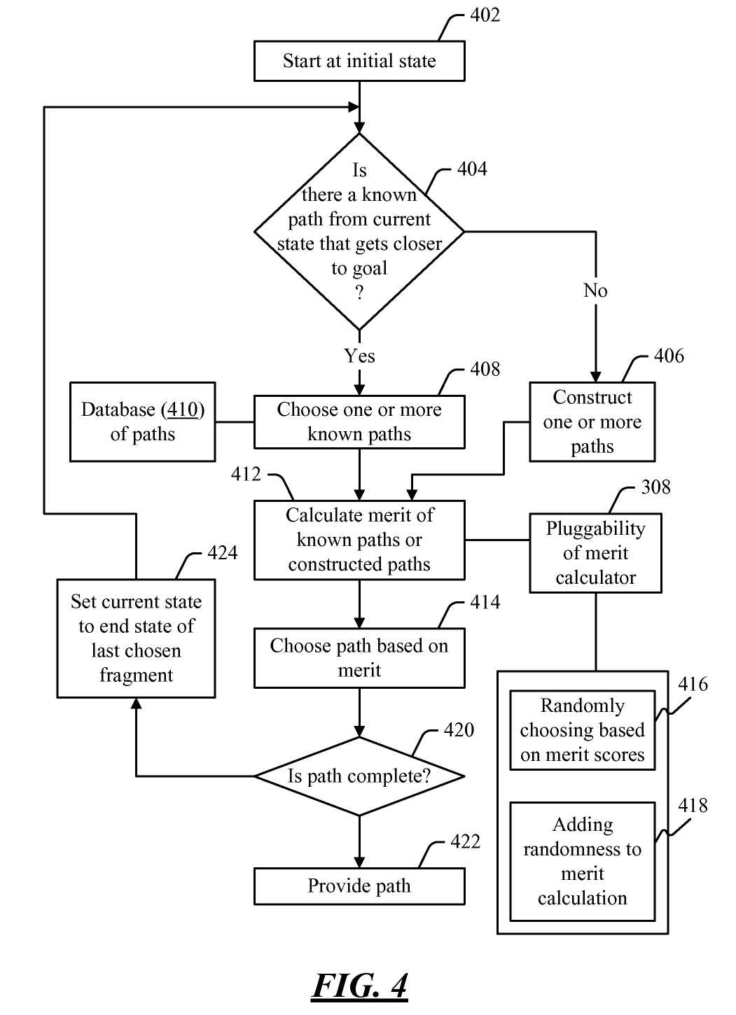

Once the query has been received, a path through a set of activities in the graph may be retrieved, or may be built or synthesized from retrievable components of the graph (at 210). An example process by which such a path may be built is shown in FIG. 3 and is described below. One action performed in the process is using rules to determine which paths to choose (block 212). A detailed example of the use of rules is shown in FIG. 4, which depicts the specific case in which the rules for choosing paths are based on scoring the merit of possible path fragments.

Returning to FIG. 2, once a path has been created, a plan based on the path is provided to the user who requested the plan (at 214). In the examples above, the plan is a suggested social agenda, although the plan could be any type of plan—e.g., a plan for achieving business goal, a plan for remodeling a room, etc. In general, the techniques described herein can be applied in any situation where results are achieved through sequences of actions, and in which those sequences of actions can be replicated and/or combined with other sequences of actions.

FIG. 3 describes an example process of generating a plan that responds to a query. At 302, the process starts at a state. The “state” is the beginning of the plan that is being sought. In one example, the query specifies the beginning (and/or ending) of the plan. E.g., “plan an evening that starts with drinks and ends with a movie”; in this example, the starting state (“drinks”) and ending state (“movie”) are defined by the query. In another example, the query does not explicitly specify the starting or ending state, in which case a starting or ending state may be chosen as the starting point for the process. For example, if the query is simply “plan an evening,” then the starting state may be an “empty” state that can lead to any activity. Or, if the query is “plan something for me to do after work,” then the starting state may be the user's office. It is noted that—while FIG. 3 describes an example in which the process of building a path starts with the starting state and works toward the ending state (or “goal”), similar techniques could be used to build a path from the ending state to the starting state, or outward from the middle toward both ends. (The latter scenario might be appropriate if the user's request is “We want to see a movie, and we need something to do both before and after.”)

At 304, a fragment is chosen to get from the current state to another state. A fragment is a path that contains at least two states. One way to choose a fragment is to use a merit calculation 306. The process of using merit calculation 306 will be described in greater detail in FIG. 4. For the purpose of FIG. 3, however, it is merely assumed that there is some way of identifying possible candidate paths, and of evaluating the merit of choosing one of these paths. Merit calculation 306 represents all appropriate methods producing a score that represents the merit of choosing a particular path. It is noted that merit calculation 306 may have a pluggability feature 308, in the sense that merit calculation 306 may be programmable (so as to allow the criteria for the calculation to be modified), or replaced entirely by a different calculator. An entity, such as a user or administrator, may perform this modification, or may perform replacement of the calculator component that is used to make the calculation. For example, a user might be particular risk averse to trying new things, and might choose a merit calculation that assigns a high merit to paths that are well-trodden. Or, the user might be “up for anything,” and might choose a merit calculation that introduces an element of randomness into the evaluation of merit. There may be a user interface that allows a user to adjust specific parameters governing how merit is calculated, but in theory a user or administrator could write a merit calculator from scratch according to an object model, and could plug a new merit calculator into a system. Some details of how a merit calculation would be performed, and considerations surrounding the merit calculation, are discussed below in connection with FIG. 4.

At 310, it is determined whether the goal (“ending state”) of the plan is reached. As with the starting state, this goal could be well defined (e.g., “plan an evening that starts with drinks and ends with a movie”), or might be open ended (e.g., “plan an evening that starts at a restaurant in Seattle”). If the goal is reached, then the path is complete, and a plan based on the path may be provided to a user (at 312). For example, if the path represents a social agenda, then the plan provided to the user might be:
Start at Ruth's Chris in downtown Seattle for drinks;
Then go to El Gaucho in Belltown;
Then drive to Lincoln Square Cinema in Bellevue;
Then call it a night and go home.

If it is determined at 310 that the goal has not been reached, then the current state is set equal to the end state of the last chosen fragment (at 314), and the process then returns to 304 to choose the next fragment to get from the current state to another state.

It is noted that there may be rules governing how fragments can be combined to form a path. For example, there may be a rule that fragments have to overlap in at least one edge (or, more generally, to overlap in n edges). In other words, the path Starbucks to El Gaucho to Lincoln Square, and El Gaucho to Lincoln Square to Kirkland Bowling might be joinable because they share the El Gaucho-to-Lincoln Square edge in the graph. By the same logic, the path Starbucks-to-Library might not be joined with the path Library-to-Kirkland-Bowling; even those both paths share the “library” node, they have no edge in common. Insisting that paths share an edge in common may make a synthesized path seem less “choppy” or “disjointed” than one in which transitions from node to node are created on speculation without having been observed in a real life setting. However, the subject matter herein includes systems that do create such edges speculatively. Moreover, the way in which edge commonality is taken into account can be implemented in various ways, including as part of the merit calculation. That is, when calculating the merit of a fragment, one way to take edge commonality into account is to increase the merit score based on how many edges the current fragment has in common with the last one.

As noted above, it was assumed in FIG. 3 that there is some way of calculating the merit of fragments, and choosing fragments based on these merit calculations. FIG. 4 shows a detailed example of how a merit calculation may be used, and how fragments may be chosen.

In FIG. 4, the process of choosing the next fragment in a path starts at an initial state (at 402), which, for the purpose of the terminology used in FIG. 4, is now the “current” state. At 404, it is determined whether there is a known path that passes through the current state and gets closer to the goal, or ending, state. If no such path exists, then the process constructs one or more paths (at 406). It is noted that the process of FIG. 4 may favor existing, known paths—e.g., those paths that have been observed to have been experienced by a person. However, the process may be able to create such a path speculatively if no known path is available. If a particular stage in the construction of a path involves moving from state A to state B, and there is no known path that can achieve state B from state A, then the process of FIG. 4 may be able to create such a path. For example, if the current state is “El Gaucho” and the user has indicated that he wants the evening to end with a movie, but no one has ever been observed to go to a movie after El Gaucho, then the system can simply create a transition, such as “from El Goucho, go to Starbucks near the movie theater, then go to the movie.” The transition may be “uncharted”, but the system can create the transition, and may be able to assign a merit score to such a transition. The path construction process, and/or the merit calculation on newly-created paths, may use criteria such as time and place in order to come up with realistic paths. For example, it is theoretically possible to start the evening at a Seattle coffee house and end up at a Chicago bar, but for many people it is impractical to do so. Thus, the process of path creation might impose a spatial criterion so that Seattle-coffee-to-Chicago-bar will not be proposed (unless the user has explicitly requested a geographically far-flung evening, such as by entering the query “evening that makes stops across North America”). Or, as another example, the path construction process might take scheduling and other time issues into account—e.g., if one point in the path is an 11:00 p.m. movie, the system could avoid creating a path that goes from this movie to a coffee house that closes at 10:00 p.m.

On the other hand, if it was determined at 404 that a known path does exist (e.g., in the stored graph 108, shown in FIG. 1), then one or more such paths may be chosen (at 408). There may be a database 410 of paths, and this database may be accessed in order to search for and obtain the known paths. With regard to how the paths are to be chosen, the following points are noted. First, the act of choosing a known path may include choosing a subset of a known path. For example, an actual observed path might be A->B->C->D->E->F. If the current state is C, then a portion of this path such as C->D->E, or C->D->E->F, or C->D may be chosen. In other words, it is possible to use a part of a known path, rather than the whole path. Second, there may be several known paths that run through the current state, but the act of choosing one or more known paths might choose some subset of the set of such paths. As described below, the paths that are chosen are evaluated for merit, and only one such path will actually be part of the plan that is proposed to the user. However, in one example, even before the paths are evaluated for merit, the act of choosing a known path may choose only a small number of possible paths—e.g., if the current state is C and there are a thousand known paths that run through C, the system might randomly choose five such paths (or might choose five paths based on some criterion), and then may apply the merit calculation to these five paths. This technique may reduce the number of calculations that have to be performed when a path is being chosen.

Regardless of whether the path(s) chosen are pre-existing stored paths, or paths that have been constructed, the process continues to 412, where the merit of the path(s) is calculated. As noted above, the calculator components that makes the merit calculation may be pluggable (feature 308), which allows entities such as users or administrators to modify the rules under which merit is calculated, or to replace the calculation component with a new component. When the merit has been calculated, path may be chosen based on merit (at 414).

It is noted that the act of choosing a path based does not necessarily mean choosing the path with the highest merit score. In one example, the system adds an element of randomness to the path (e.g., in order to prevent recommending the exact same set of social plans to a user many times). There are two ways to introduce this randomness. One way (block 416) is to calculate merit scores for the various paths, but to introduce randomness into the way the path is chosen. For example, if there are two proposed paths, path A with a merit score of 0.6 and path B with a merit score of 0.4, then the system may model this situation as a random variable that is weighted so as to have a 60% chance of choosing A and a 40% chance of choosing B. In other words, the fact that path A has a higher merit score is taken into account in the final choice, but only in the sense that it gives path A a higher chance of being chosen, not in the sense of mandating a choice of path A. Another way to introduce randomness into the choice (block 418) is to choose the path with the higher score, but to add randomness to the merit calculation itself. For example, the merit score might be based on several objective factors, plus a random factor, thereby making it possible for a path that scores lower on objective criteria to receive a higher merit score if the random component happens to contribute a large number of points to the score. In this sense, the pluggability feature 308 may come into play, in order to modify and/or replace the merit calculator to introduce an element of randomness into the merit calculation.

At 420, it is determined whether the path is complete. If the path is complete, then the path may be provided at 422. In the example where the path is a sequence of events that are part of a social agenda, then the act of providing the path may include communicating and/or displaying a social agenda (such as that described above) to a user. It is noted that the system may communicate partial results to a user, before a complete result is available. For example, if the system is in the process of generating a social agenda but knows that the first event will be coffee at Starbucks, it can show the user that first item on the agenda even while it continues generating the rest of the agenda. Providing such partial results may reduce the user's perception of latency, since the user can see information being provided in response to a query even before a full response to the query is available.

If it is determined at 420 that the path is not complete, then the current state is set equal to the end state of the last chosen path fragment (at 424), and the process returns to 404 to choose the next fragment.

It is noted that the system does not have to stop creating paths when a single path has been created. Rather, the user could create multiple paths, and present these multiple paths to the user. When there are multiple paths, paths might be ranked, similarly to how search results are ranked. The ranking of results could be based on the merit calculation described above.

Additionally, it is noted that—once a path has been created—the path can be re-used as input to the system. For example, if a social agenda of events has been created, that social agenda may then be used as data to augment the graph 108 that was described above in connection with FIG. 1. As noted above, one aspect of the graph 108 shown in FIG. 1 is that it contains paths that people have actually been experienced by people. If a path that has been created by the process above (but that has not yet been carried out by a person) is added to the graph, the fact that the path has not been carried out may be noted, and this fact may be taken into account when evaluating the merits of a path. Of course, if a path is created and is then actually carried out by a person, the graph may be updated to note this fact as well.

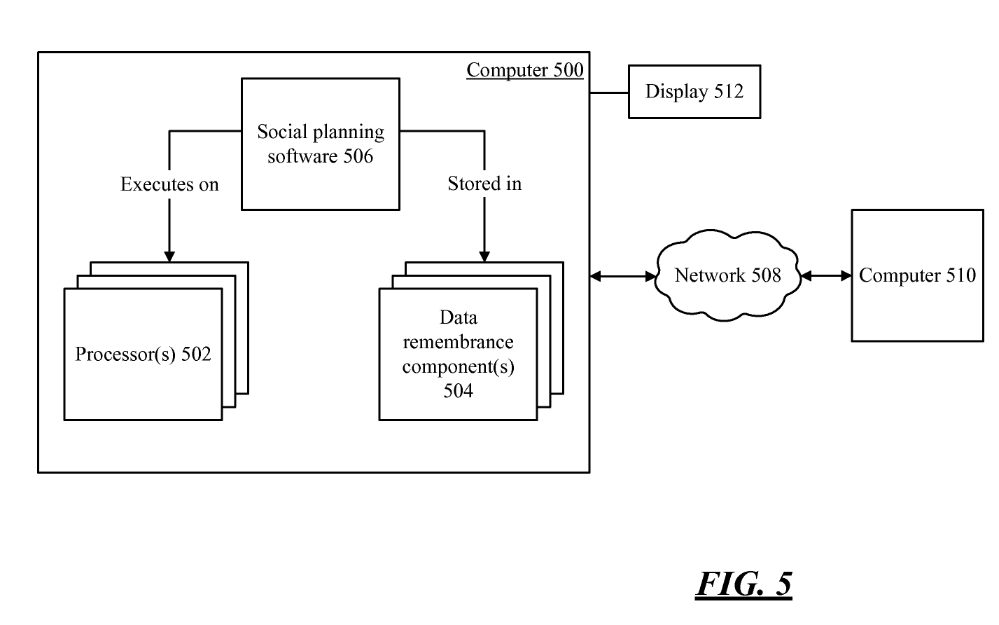

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is social planning software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium having executable instructions to perform a method of creating a social agenda, the executable instructions, when executed by a computer, causing the computer to perform acts comprising:
collecting a plurality of agendas carried out by people;
creating a graph of events and paths between events based on said plurality of agendas;
receiving, from a user, a request to provide a social agenda;
building the social agenda by constructing a path through said events in said graph based on existing paths, said existing paths, or fragments of said existing paths, being chosen for said path based on merit scores produced by a merit calculator; and
communicating the social agenda to said user.

2. The computer-readable medium of claim 1, said acts further comprising:
anonymizing said plurality of agendas by removing, from said plurality of agendas, events that are specific to people who carried out said agendas.

3. The computer-readable medium of claim 1, said constructing of said path being further based on created paths that include transitions between events that are not included in said plurality of agendas.

4. The computer-readable medium of claim 1, said merit calculator being pluggable so as to be capable of being replaced with a different merit calculator.

5. The computer-readable medium of claim 1, said merit calculator being programmable so as to allow modification, by an entity, of a way in which said merit calculator calculates a merit score for a path.

6. The computer-readable medium of claim 1, said creating of said graph comprising separately storing sub-paths of said paths, said sub-paths representing parts of said agendas.

7. The computer-readable medium of claim 1, said existing paths, or said fragments, being chosen by a process that includes randomness, said randomness being implemented by adding a random component to said merit calculator such that merit scores produced by said merit calculator are based partly on a random element and not entirely on objective merit of said paths or fragments.

8. A method of creating a sequence of events, the method comprising:
using a processor to perform acts comprising:
collecting a plurality of sequences of events carried out by people;
creating a graph of paths between events based on said sequences of events;
building a plan based on a query by constructing a path through said graph based on existing paths, said existing paths, or fragments of said existing paths, being chosen for said path based on merit scores produced by a merit calculator, said merit calculator being pluggable, said plan being a sequence of events to be performed; and
communicating the plan to a user.

9. The method of claim 8, said acts further comprising:
generating said query reactively based on said user's context.

10. The method of claim 8, said constructing of said path being further based on created paths that include transitions between events that are not included in said plurality of sequences of events, said created paths being chosen based on spatial or time constraints on said events or on transitions between events.

11. The method of claim 8, said merit calculator being programmable so as to allow modification, by an entity, of a way in which said merit calculator calculates a merit score for a path.

12. The method of claim 8, said existing paths, or said fragments, being chosen by a process that includes randomness, said randomness being implemented by calculating merit scores for said existing paths or said fragments and choosing an existing path or fragment by a random process that is weighted in favor of paths or fragments that have higher merit scores.

13. The method of claim 8, said existing paths, or said fragments, being chosen by a process that includes randomness, said randomness being implemented by adding a random component to said merit calculator such that merit scores produced by said merit calculator are based partly on a random element and not entirely on objective merit of said paths or fragments.

14. A system for creating a social agenda, the system comprising:
a memory;
a processor; and
a component that is stored in said memory, that executes on said processor, that collects a plurality of agendas carried out by people, that creates a graph of events and paths between events based on said plurality of agendas, that receives, from a user, a request to provide a social agenda, that builds the social agenda by constructing a path through said events in said graph based on existing paths, said existing paths, or fragments of said existing paths, being chosen for said path based on merit scores produced by a merit calculator, and that communicates the social agenda to said user.

15. The system of claim 14, said component anonymizing said plurality of agendas by removing, from said plurality of agendas, events that are specific to people who carried out said agendas.

16. The system of claim 14, constructing of said path by said component being further based on created paths that include transitions between events that are not included in said plurality of agendas.

17. The system of claim 14, said merit calculator being pluggable so as to be capable of being replaced with a different merit calculator.

18. The system of claim 14, said component communicating said social agenda by communicating a part of said social agenda before said social agenda has been completely generated.

19. The system of claim 14, said existing paths, or said fragments, being chosen by a process that includes randomness, said randomness being implemented by calculating merit scores for said existing paths or said fragments and choosing an existing path or fragment by a random process that is weighted in favor of paths or fragments that have higher merit scores.

20. The system of claim 14, said component producing a plurality of social agendas, including said social agenda, and presenting said plurality of social agendas to said user in an order based on ranking.
